(19) United States
(12) Patent Application Publication
(10) Pub. No.: US 2013/0153366 A1
(43) Pub. Date: Jun. 20, 2013

(54) CASE TIPPING MACHINE AND METHOD OF TIPPING CASES

(71) Applicants: Jerome Kisch, Hastings, MN (US); David C. Sellner, Robbinsdale, MN (US); Jamison Shelley, Saint Paul, MN (US)

(72) Inventors: Jerome Kisch, Hastings, MN (US); David C. Sellner, Robbinsdale, MN (US); Jamison Shelley, Saint Paul, MN (US)

(73) Assignee: THIELE TECHNOLOGIES, INC., Minneapolis, MN (US)

(21) Appl. No.: 13/466,269

(22) Filed: May 8, 2012

Related U.S. Application Data
(60) Provisional application No. 61/484,075, filed on May 9, 2011.

(51) Int. Cl. B65G 47/252

(52) U.S. Cl. 198/411

(57) ABSTRACT

A machine and associated method for tipping a cuboidal unit onto its leading face. The machine includes a conveyor, a stop for contacting a leading face of conveyed units so as to arrest continued machine direction conveyance of the conveyed units, and a tipping means, such as a driven friction wheel spaced a vertical distance above the stop, for contacting an arrested unit and driving an upper portion of the unit forward so as to tip the unit over the stop.

This application claims the benefit of U.S. Provisional Application No. 61/484,075, filed May 9, 2011.

### BACKGROUND

Stackable cases, such as the 13 inch by 13 inch plastic cases used in the dairy industry to store and ship containers of milk, need to be unstacked and tipped over so that the open top of the container is facing downward for washing-out the cases.

A number of unstacking machines are commercially available to accomplish the desired unstacking. These machines typically rely upon a dropoff to tip the unstacked cases into the desired upside-down orientation. While generally effective, such gravity fed tipping units can be unreliable at times.

Hence, a substantial need exists for a reliable mechanism for tipping unstacked cases.

### SUMMARY OF THE INVENTION

A first aspect of the invention is a tipping machine. The machine includes (a) a conveyor for conveying a cuboidal unit in a machine direction along a path of conveyance, (b) a stop configured and arranged for contacting a leading face of a conveyed unit so as to arrest continued machine direction conveyance of the conveyed units, and (c) a tipping means for contacting an arrested unit and tipping the unit over the stop, whereby the unit is rotated onto the leading face of the unit.

The stop is preferably configured and arranged to define a pivot line about which an arrested unit will pivot upon commencement of tipping which is less that 6 inches above the conveyor surface.

The preferred tipping means is a driven wheel biased in a cross direction towards the path of conveyance, and configured and arranged to contact an arrested unit at a contact point above the pivot line.

A second aspect of the invention is a method of tipping a cuboidal unit using a tipping machine in accordance with the first aspect of the invention. The method includes the steps of (a) obtaining a cuboidal unit, (b) obtaining a tipping machine in accordance with the first aspect of the invention, (c) conveying the cuboidal unit in the machine direction on the coveyor of the tipping machine until the leading face of the unit contacts the stop and continued movement of the unit in the machine direction is arrested, and (d) driving the arrested unit forward in the machine direction at a contact point on the unit that is transversely above the pivot line defined by the stop, whereby the unit is rotated over the stop and rests upon the leading face of the unit.

### BRIEF DESCRIPTION OF THE DRAWINGS

FIG. 1 is a schematic side view of one embodiment of the present invention mounted onto a top-out-unstacker.

FIG. 2 is an enlarged perspective view of the invention depicted in FIG. 1 sans conveyor chains and with safety housings removed to facilitate viewing of internal components.

FIG. 3 is a further enlarged perspective view of the upstream end of the invention depicted in FIG. 2.

FIG. 4 is a further enlarged perspective view of the downstream end of the invention depicted in FIG. 2.

FIG. 4A is a side view of the downstream end of the invention depicted in FIG. 4.

FIG. 4B is a top view of the downstream end of the invention depicted in FIG. 4.

FIG. 5 is a perspective view of the downstream end of the invention depicted in FIG. 4 showing an arrested cuboidal unit and a tipped cuboidal unit.

### DETAILED DESCRIPTION OF A PREFERRED EMBODIMENT

### 10 Nomenclature

20 Cuboidal Unit Tipping Machine
30 Framework
30a Conveyor
30a Upstream End of Conveyor
30b Downstream End of Conveyor
32 Vertical to Horizontal Guide Rails
34 In-feed Guide
40 Stop Member
50 Tipping Subassembly
51 Pivot Axle
52 Mounting Plate
53 Motor
54 Gear Box or Transmission
55 Axle
56 Friction Wheel
57 Inward Biasing Mechanism (Pneumatic Cylinder—alternatively a Compression Spring)
A Top-Out Unstacker
U Cuboidal Unit (such as a stackable 13×13 dairy case)
U1 Leading Face of Cuboidal Unit
C Cross Direction
M Machine Direction
T Transverse Direction

### Construction

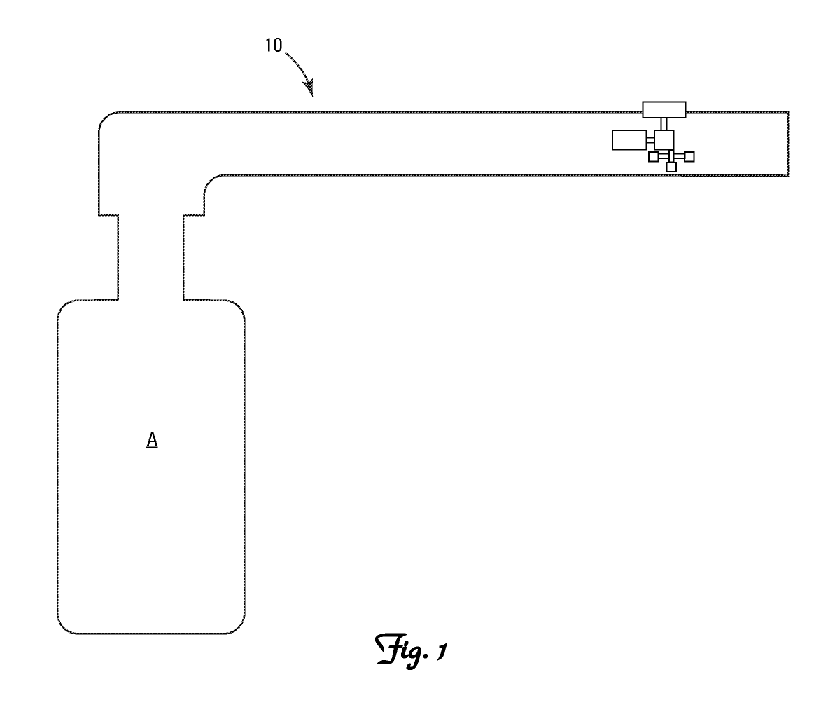

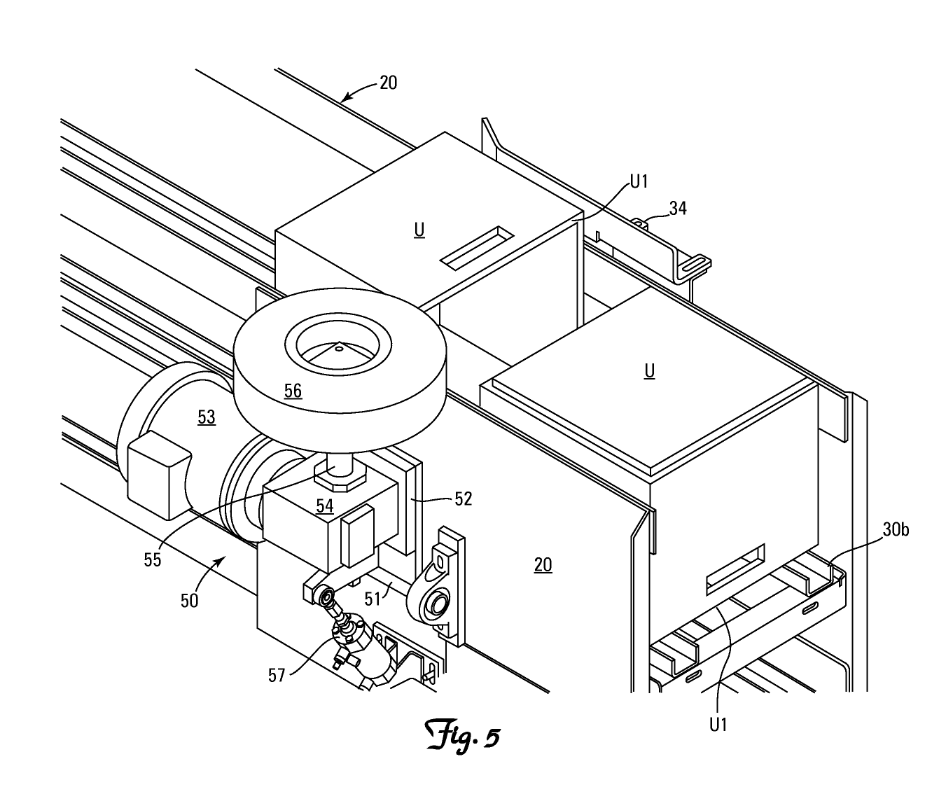

The invention is a tipping machine 10 configured and arranged for use with an unstacker A such as a top-out unstacker A depicted in FIG. 1, for tipping the unstacked cuboidal units U over onto their leading face U1 such as depicted in FIG. 5.

The unstacker A may be selected from any of the machines widely available from a number of suppliers. An exemplary top-out unstacker A is an EU10 Top-Out Unstacker available from Thiele Technologies, Inc. of Minneapolis, Minn.

The tipping machine 10 includes suitable supporting and guiding framework 20, a conveyor 30, a stop member 40, and a tipping subassembly 50.

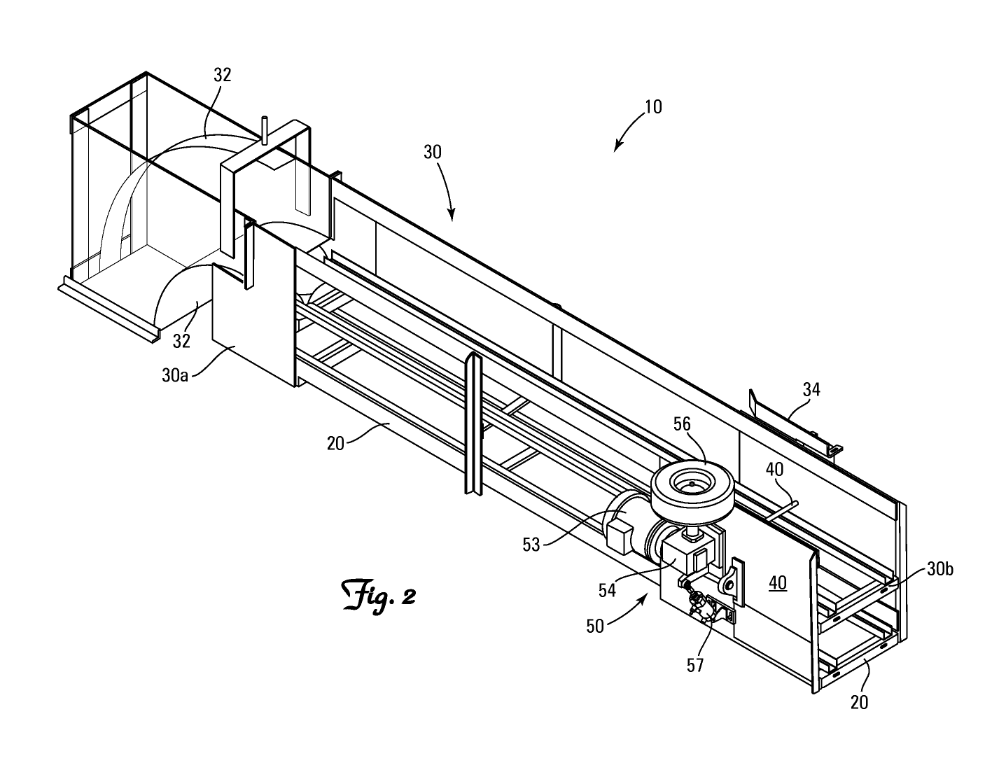

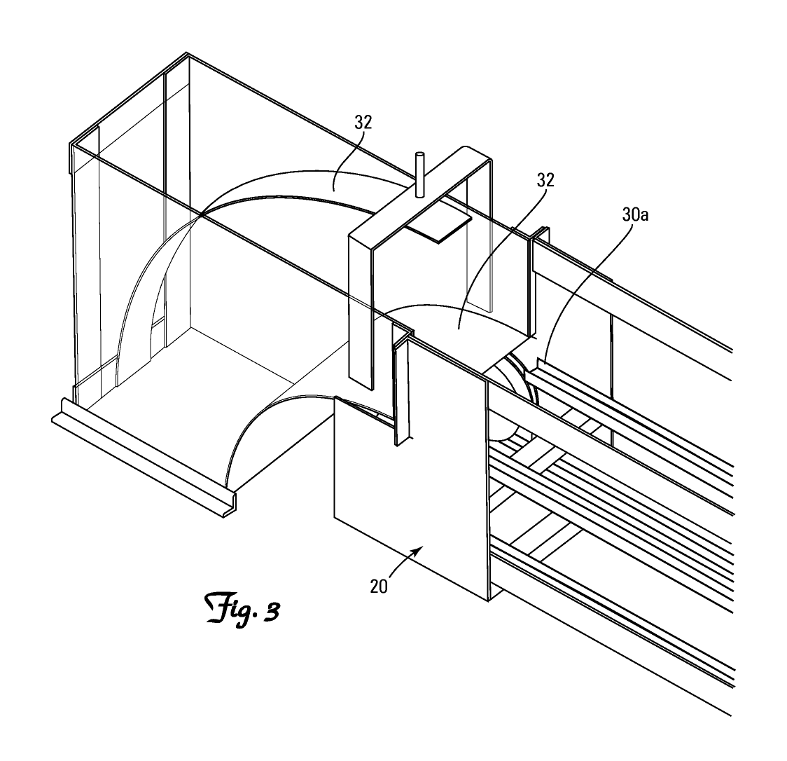

Referring generally to FIG. 2, the conveyor 30 is configured and arranged for conveying a cuboidal unit U in a machine direction M along a path of conveyance. Referring to FIGS. 2 and 3, upper and lower vertical-to-horizontal guide rails 32 are provided proximate the intake or upstream end 30a of the conveyor 30 for redirecting cuboidal units U as they are unstacked by an unstacker A from a vertical or transverse T path to a horizontal or machine M path. The guide rails 32 also effect a 90° rotation of each redirected cuboidal unit U so that what used to be the top face of the cuboidal unit U when stacked becomes the leading face U1 of the cuboidal unit U as it is conveyed in the machine M direction by the conveyor 30.

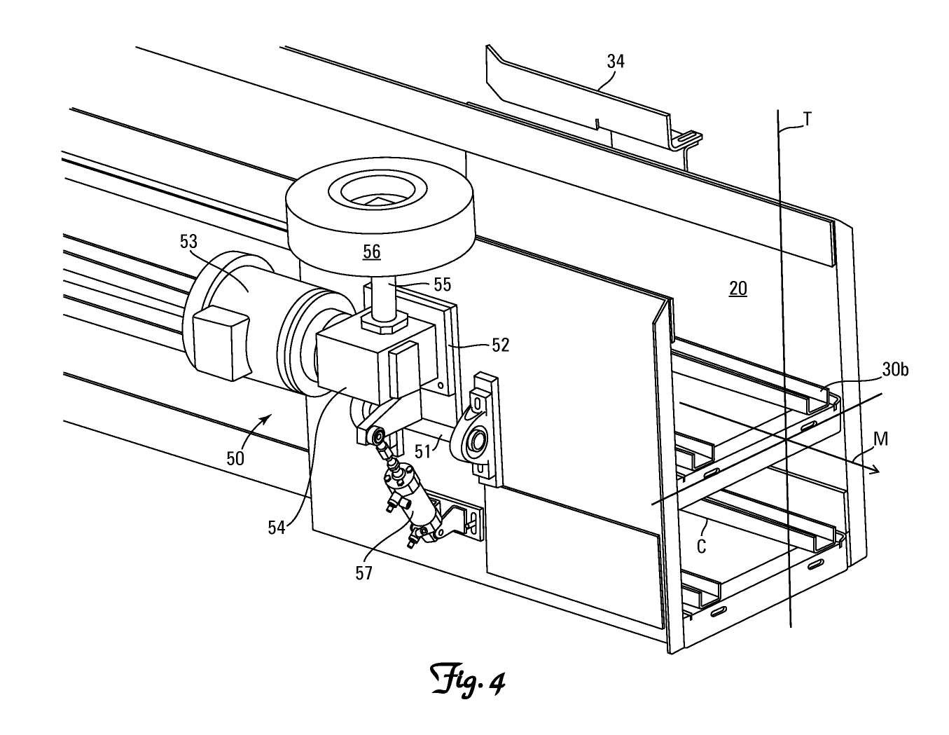

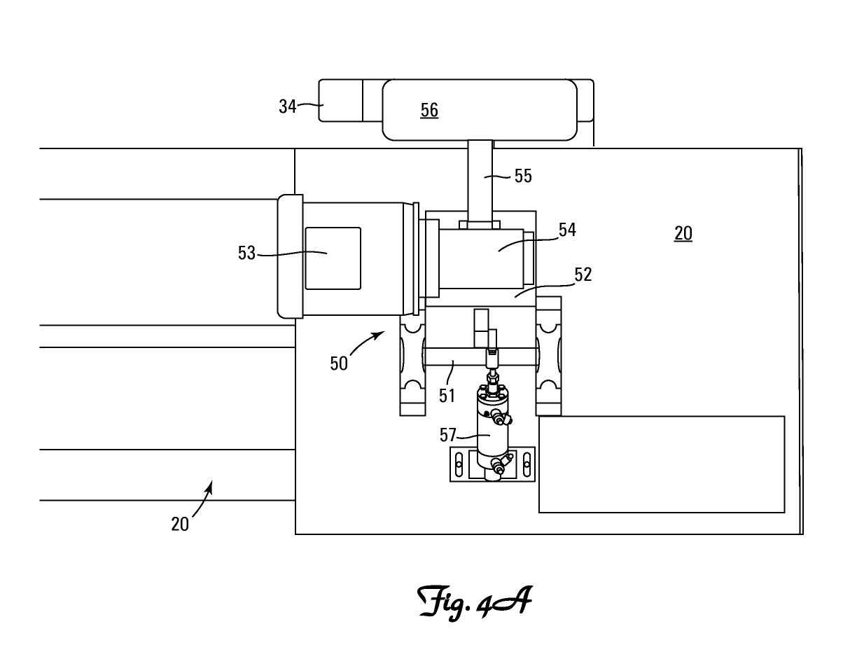

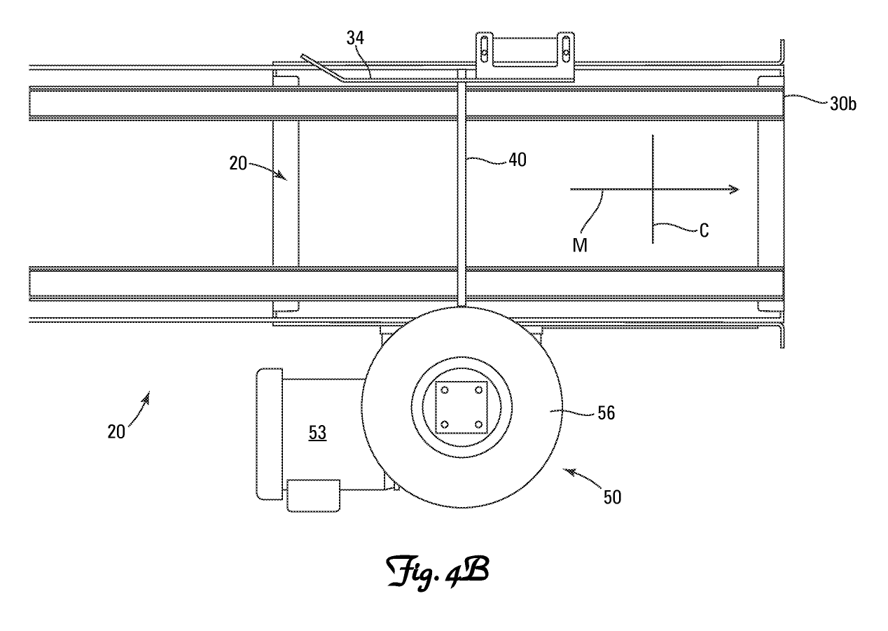

Referring to FIGS. 2 and 4B, the stop 40 is located downstream from the intake or upstream end 30a of the conveyor 30, preferably proximate the downstream end 30b of the conveyor 30. The stop 40 configured and arranged for contacting a leading face U1 of a conveyed unit U so as to arrest continued machine M direction conveyance of the conveyed units U. The stop 40 need not but preferably does extend in a cross C direction entirely across the path of conveyance.

The stop 40 defines an imaginary pivot line (not depicted) extending in a cross C direction about which an arrested unit U will pivot upon commencement of tipping. This imaginary pivot line will generally be located at the uppermost interface between an arrested unit U and the stop 40 prior to commencement of tipping. Generally, this pivot line should be transversely T spaced about 1 to 6 inches above the conveyance surface of the conveyor 30. A spacing of less than about 1 inch provides minimal clearance between the conveyor belt (not separately numbered) and the stop 40, increasing the risk that the stop 40 may contact and damage the conveyor belt (not separately numbered), while a spacing of more than about 6 inches tends to unnecessarily hamper tipping of the units U over the stop 40 and produce undesired bouncing of the tipped units U as they fall from the stop 40 back onto the conveying surface.

Referring to FIGS. 2, 4, 4A, 4B and 5, the tipping subassembly 50 is positioned proximate the stop 40 for contacting an arrested unit U and tipping the arrested unit U over the stop 40, thereby rotating the arrested unit U 90° so that the unit U now rests upon the leading face U1 of the unit U (i.e., what used to be the top face of the cuboidal unit U when stacked) and the leading face U1 faces downward.

Referring to FIGS. 4, 4A, 4B and 5, a preferred embodiment of the tipping subassembly 50 includes a motor 53 driven friction wheel 56 mounted alongside the conveyor 30. A gearbox or transmission 54 may be provided between the motor 53 and the friction wheel 56 for facilitating changes and adjustments in friction wheel 56 rpm. The friction wheel 56 is preferably mounted atop an axel 55 and biased in a cross C direction towards the path of conveyance by a suitable biasing means 57 (e.g., a pneumatic cylinder or a spring). One assembly for achieving such an inward biasing of the friction wheel 56 includes mounting the friction wheel 56, motor 53 and gearbox 54 onto a mounting plate 52 which is pivotably attached to the frame 20 via a pivot axle 51 extending in the machine M direction, and biasing the mounting plate 52 towards the path of conveyance with the biasing means 57.

Referring to FIGS. 4, 4A and 4B, to ensure good frictional contact between the friction wheel 56 and an arrested unit U and avoid cross C direction skewing of an arrested unit U by the friction wheel 56, an in-feed guide 34 is preferably mounted to the frame 20 immediately across from the friction wheel 56.

The friction wheel 56 needs to rotate in a direction which effects movement of an arrested unit U in a machine M direction into and over the stop 40, which for the embodiment depicted in the accompanying Figures would be a clockwise direction when viewed from above.

In order to provide smooth and reliable tipping of units U over the stop 40, the ratio of (i) transverse T distance from conveyor surface to stop 40 (i.e., pivot line) to (ii) transverse T distance from stop 40 (i.e., pivot line) to point at which friction wheel 56 will contact an arrested unit U, should be between 1:1 and 1:20, preferably between 1:2 and 1:10, and most preferably between 1:3 and 1:4.

All components of the tipping machine 10 should be constructed from material having sufficient durability and structural integrity to withstand extended periods of rapid and repetitive movement, such as steel and nylon.

### Use

Referring to FIG. 5, an unstacked cuboidal unit U can be tipped “upside down” by a tipping machine 10 in accordance with this invention by (i) redirecting movement of an unstacked cuboidal unit U as it exits an unstacker A from a vertical or transverse T direction to a horizontal or machine M direction, (ii) pivoting the cuboidal unit U 90° as it is being redirected so that the face of the cuboidal unit U faced upward when received becomes the forward or leading face U1 of the cuboidal unit U as it is conveyed by the tipping machine 10 in the machine M direction, (iii) conveying the pivoted cuboidal unit U in the machine M direction until continued movement of the unit U in the machine M direction is arrested by the stop 40, and (iv) tipping the arrested unit U over the stop 40 with the friction wheel 56 whereby the unit U is rotated onto its leading face U1 downstream from the stop 40.

We claim:

1. A tipping machine, comprising:
(a) a conveyor for conveying a cuboidal unit in a machine direction along a path of conveyance,
(b) a stop configured and arranged for contacting a leading face of a conveyed unit so as to arrest continued machine direction conveyance of the conveyed units, and
(c) a tipping means for contacting an arrested unit and tipping the unit over the stop, whereby the unit is rotated onto the leading face of the unit.

2. The tipping machine of claim 1 wherein the cuboidal unit is a rectangular cuboidal unit.

3. The tipping machine of claim 1 wherein the cuboidal unit is a square cuboidal unit.

4. The tipping machine of claim 1 wherein the stop is a rod that extends completely across the path of conveyance.

5. The tipping machine of claim 1 wherein the conveyor defines a conveyor surface for supporting cuboidal units, the stop is configured and arranged to define a pivot line about which an arrested unit will pivot upon commencement of tipping, and the pivot line is less that 6 inches above the conveyor surface.

6. The tipping machine of claim 5 wherein the pivot line is less than 2 inches above the conveyor surface.

7. The tipping machine of claim 5 wherein the tipping means is a driven wheel configured and arranged to contact an arrested unit at a contact point above the pivot line.

8. The tipping machine of claim 5 wherein the driven wheel is biased in a cross direction towards the path of conveyance.

9. The tipping machine of claim 5 wherein the tipping means is configured and arranged to contact an arrested unit a transverse distance above the conveyor surface that is at least twice the transverse distance between the conveyor surface and the pivot line defined by the stop.

10. The tipping machine of claim 5 wherein the tipping means is configured and arranged to contact an arrested unit a transverse distance above the conveyor surface that is at least three times the transverse distance between the conveyor surface and the pivot line defined by the stop.

11. The tipping machine of claim 5 wherein the tipping means is configured and arranged to contact an arrested unit a transverse distance above the conveyor surface that is at least four times the transverse distance between the conveyor surface and the pivot line defined by the stop.

12. A method of tipping a cuboidal unit, comprising the steps of:
(a) obtaining a cuboidal unit,
(b) obtaining a tipping machine in accordance with claim 1,
(c) conveying the cuboidal unit in the machine direction on the conveyor of the tipping machine until the leading face of the unit contacts the stop and continued movement of the unit in the machine direction is arrested, and
(d) driving the arrested unit forwarding in the machine direction at a contact point on the unit that is transversely above the pivot line defined by the stop, whereby the unit is rotated over the stop and rests upon the leading face of the unit.

13. The method of claim 12 wherein the cuboidal unit is pivoted 90°.

14. A method of tipping a cuboidal unit, comprising the steps of:
(a) obtaining a cuboidal unit,
(b) obtaining a tipping machine in accordance with claim 4,
(c) conveying the cuboidal unit in the machine direction on the conveyor of the tipping machine until the leading face of the unit contacts the stop and continued movement of the unit in the machine direction is arrested, and
(d) driving the arrested unit forward in the machine direction at a contact point on the unit that is transversely above the pivot line defined by the stop, whereby the unit is rotated over the stop and rests upon the leading face of the unit.

15. A method of tipping a cuboidal unit, comprising the steps of:
(a) obtaining a cuboidal unit,
(b) obtaining a tipping machine in accordance with claim 5,
(c) conveying the cuboidal unit in the machine direction on the conveyor of the tipping machine until the leading face of the unit contacts the stop and continued movement of the unit in the machine direction is arrested, and
(d) driving the arrested unit forward in the machine direction at a contact point on the unit that is transversely above the pivot line defined by the stop, whereby the unit is rotated over the stop and rests upon the leading face of the unit.

16. A method of tipping a cuboidal unit, comprising the steps of:
(a) obtaining a cuboidal unit,
(b) obtaining a tipping machine in accordance with claim 7,
(c) conveying the cuboidal unit in the machine direction on the conveyor of the tipping machine until the leading face of the unit contacts the stop and continued movement of the unit in the machine direction is arrested, and
(d) driving the arrested unit forward in the machine direction at a contact point on the unit that is transversely above the pivot line defined by the stop, whereby the unit is rotated over the stop and rests upon the leading face of the unit.

17. A method of tipping a cuboidal unit, comprising the steps of:
(a) obtaining a cuboidal unit,
(b) obtaining a tipping machine in accordance with claim 8,
(c) conveying the cuboidal unit in the machine direction on the conveyor of the tipping machine until the leading face of the unit contacts the stop and continued movement of the unit in the machine direction is arrested, and
(d) driving the arrested unit forward in the machine direction at a contact point on the unit that is transversely above the pivot line defined by the stop, whereby the unit is rotated over the stop and rests upon the leading face of the unit.

18. A method of tipping a cuboidal unit, comprising the steps of:
(a) obtaining a cuboidal unit,
(b) obtaining a tipping machine in accordance with claim 9,
(c) conveying the cuboidal unit in the machine direction on the conveyor of the tipping machine until the leading face of the unit contacts the stop and continued movement of the unit in the machine direction is arrested, and
(d) driving the arrested unit forward in the machine direction at a contact point on the unit that is transversely above the pivot line defined by the stop, whereby the unit is rotated over the stop and rests upon the leading face of the unit.
